(19) United States
(12) Patent Application Publication
(10) Pub. No.: US 2026/0073511 A1
(43) Pub. Date: Mar. 12, 2026

(54) ANCHOR POINTS FOR MULTI-MODAL DATA STREAMS VERIFICATION AND CONTEXTUALIZATION

(71) Applicant: Proprio, Inc., Seattle, WA (US)

(72) Inventors: Thomas A. Carls, Seattle, WA (US); Adam Gabriel Jones, Seattle, WA (US); Neeraj Mainkar, Seattle, WA (US)

(21) Appl. No.: 18/971,602

(22) Filed: Dec. 6, 2024

Related U.S. Application Data
(60) Provisional application No. 63/692,026, filed on Sep. 6, 2024.

(51) Int. Cl. G06T 7/00

(52) U.S. Cl. CPC G06T 7/0012; G06T 2207/10016; G06T 2207/10024; G06T 2207/30012

(57) ABSTRACT

Methods of automatically generating a characterization of a surgical procedure, and associated systems and devices are disclosed herein. A representative method can include acquiring surgical procedure data of the surgical procedure including at least a first intraoperative data stream and a second intraoperative data stream different than and captured simultaneously with the first intraoperative data stream. The method can further include determining a first context in the first intraoperative data stream at a time in the first intraoperative data stream and, based on the determined first context, determining a corresponding second context in the second intraoperative data stream at and/or proximate the same time in the second intraoperative data stream. The method can further include utilizing an artificial intelligence application to convert at least a portion of the first and second intraoperative data streams and the first and second contexts into a natural language description characterizing the surgical procedure.

### CROSS-REFERENCE TO RELATED APPLICATION

This application claims priority to U.S. Patent Application No. 63/692,026 filed on Sep. 6, 2024, and titled “ANCHOR POINTS FOR MULTI-MODAL DATA STREAMS VERIFICATION AND CONTEXTUALIZATION,” which is hereby incorporated by reference in its entirety.

### TECHNICAL FIELD

The present technology generally relates to methods, systems, and devices for determining context across different intraoperative data streams based on anchor points. The context can be used as an input to an artificial intelligence (AI) algorithm configured to generate a natural language description characterizing a surgical procedure.

### BACKGROUND

Intraoperative data refers to the real-time information collected and utilized during surgical procedures to enhance decision-making, improve patient outcomes, and ensure surgical precision. This data can encompass a wide range of information, including patient vital signs, imaging results, and surgical instrument tracking. The integration of technologies such as intraoperative imaging (e.g., MRI, CT scans), real-time monitoring systems, and computer-assisted surgical tools allows surgeons to visualize the operative field with greater clarity, adjust their techniques dynamically, and respond promptly to any complications.

However, such intraoperative data may be difficult to automatically verify and/or contextualize. For example, a surgical event may not be recognizable in each modality of intraoperative data. As one example, a spinal surgical procedure may include surgically exposing a portion of a patient's vertebra. However, which vertebra (e.g., L5) is surgically exposed may not be automatically recognizable/determinable in an intraoperative video stream of the spinal surgical procedure without additional information because the video stream does not include enough detail due to the structural similarity of different vertebrae, due to partial occlusion of the vertebra, etc. Such context would be helpful in reviewing the intraoperative data postoperatively.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 is a schematic view of an imaging system in accordance with embodiments of the present technology.

FIG. 2 is a perspective view of an environment employing the imaging system of FIG. 1 in accordance with embodiments of the present technology.

FIG. 3 is an isometric view of a portion of the imaging system of FIG. 1 illustrating four cameras of a sensor array of the imaging system in accordance with embodiments of the present technology.

FIG. 4 is a block diagram of a surgical characterization processing device in accordance with embodiments of the present technology.

FIG. 5 is a schematic illustration of different modalities of intraoperative data streams that the surgical characterization processing device of FIG. 4 can acquire, record, and/or store over an operative timeline of a surgical procedure in accordance with embodiments of the present technology.

FIG. 6 is a flow diagram of a process or method that can be carried out by the surgical characterization processing device of FIG. 1 for automatically generating a surgical characterization in accordance with embodiments of the present technology.

FIG. 7 is a flow diagram of a process or method that can be carried out by the surgical characterization processing device of FIG. 1 in accordance with additional embodiments of the present technology.

FIG. 8 is a block diagram that illustrates an example of a computer system in which at least some operations described herein can be implemented in accordance with embodiments of the present technology.

FIG. 9 is a block diagram of an example transformer.

FIG. 10 is a block diagram illustrating an architecture for large language model applications, according to some implementations.

### DETAILED DESCRIPTION

Aspects of the present technology are directed generally to methods of automatically generating a characterization of a surgical procedure, such as a spinal surgical procedure, and associated systems and devices. In some embodiments, a representative method includes acquiring surgical procedure data of the surgical procedure (e.g., a spinal surgical procedure) including at least a first intraoperative data stream and a second intraoperative data stream different than and captured simultaneously with the first intraoperative data stream. The first data stream can have a first modality (e.g., comprising registration data) and the second data stream can have a second modality (e.g., comprising video data) different than the first data stream. The method can further include determining a first context (e.g., a first feature) in the first intraoperative data stream at a time in the first intraoperative data stream and, based on the determined first context, determining a corresponding second context (e.g., a second feature) in the second intraoperative data stream at and/or proximate the same time in the second intraoperative data stream. The first and second contexts can comprise surgical actions, anatomical landmarks (e.g., targets, structures), instrument identifications, instrument movements, intraoperative events, and/or other relevant aspects of the surgical procedure. The method can further include utilizing an artificial intelligence application to convert at least a portion of the first and second intraoperative data streams and the first and second contexts into one or more natural language descriptions characterizing the surgical procedure.

In some aspects of the present technology, the methods of the present technology can automatically generate an accurate surgical characterization describing a surgical procedure by leveraging multi-modal intraoperative data streams in a manner that provides improved efficiency, accuracy, standardization, and documentation compared to any manual method for describing/characterizing a surgical procedure. Notably, the present technology can recognize context/features in the first and second intraoperative data streams having different modalities, and accurately verify and extrapolate the context/features across all intraoperative data streams. That is, for example, context/features recognized in the first intraoperative data stream that may not be automatically identifiable in the second intraoperative data stream can be used as an anchor point of system knowledge to extrapolate and integrate the context/features into the second intraoperative data stream (and/or into other data streams). Such verification and extrapolation of context/features across intraoperative data streams provides a robust data set for input to the AI application for generating the surgical characterization that would not be possible by extracting context/features independently from each intraoperative data stream.

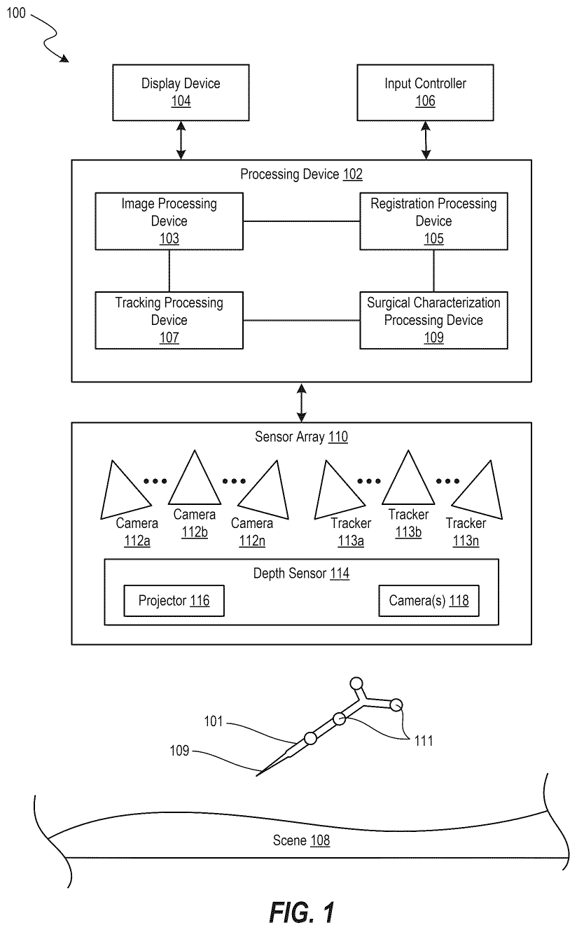

Specific details of several embodiments of the present technology are described herein with reference to FIG. 1-10. The present technology, however, can be practiced without some of these specific details. In some instances, well-known structures and techniques often associated with sensor arrays, RGB imaging, depth sensing, machine learning and artificial intelligence (AI) processes/algorithms/models, registration processes, and the like have not been shown in detail so as not to obscure the present technology.

The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section. Moreover, although frequently described in the context of generating a surgical characterization for a spinal surgical procedure, the present technology can be used to automatically generate surgical characterizations for other types of surgical procedures, such as general surgical procedures, orthopedic surgical procedures, neurosurgical procedures, laparoscopic procedures, etc.

The accompanying Figures depict embodiments of the present technology and are not intended to be limiting of its scope. Depicted elements are not necessarily drawn to scale, and various elements can be arbitrarily enlarged to improve legibility. Component details can be abstracted in the figures to exclude details as such details are unnecessary for a complete understanding of how to make and use the present technology. Many of the details, dimensions, angles, and other features shown in the Figures are merely illustrative of particular embodiments of the disclosure. Accordingly, other embodiments can have other dimensions, angles, and features without departing from the spirit or scope of the present technology.

The headings provided herein are for convenience only and should not be construed as limiting the subject matter disclosed. To the extent any materials incorporated herein by reference conflict with the present disclosure, the present disclosure controls.

### I. Selected Embodiments of Sensor Systems

FIG. 1 is a schematic view of an imaging system 100 (“system 100”) in accordance with embodiments of the present technology. In some embodiments, the system 100 can be a synthetic augmented reality system, a virtual-reality imaging system, an augmented-reality imaging system, a mediated-reality imaging system, and/or a non-immersive computational imaging system. In the illustrated embodiment, the system 100 includes a processing device 102 that is communicatively coupled to one or more display devices 104, one or more input controllers 106, and a sensor array 110 (e.g., a camera array, a sensor head, and/or the like). In other embodiments, the system 100 can comprise additional, fewer, or different components. In some embodiments, the system 100 includes some features that are generally similar or identical to those of the mediated-reality imaging systems disclosed in (i) U.S. patent application Ser. No. 16/586,375, filed Sep. 27, 2019, titled “CAMERA ARRAY FOR A MEDIATED-REALITY SYSTEM,” and/or (ii) U.S. patent application Ser. No. 15/930,305, filed May 12, 2020, and titled “METHODS AND SYSTEMS FOR IMAGING A SCENE, SUCH AS A MEDICAL SCENE, AND TRACKING OBJECTS WITHIN THE SCENE,”each of which is incorporated herein by reference in its entirety.

In the illustrated embodiment, the sensor array 110 includes a plurality of cameras 112 (identified individually as cameras 112a-n; which can also be referred to as first cameras) that can each capture images of a scene 108 (e.g., first image data) from a different perspective. The scene 108 can include for example, a patient undergoing surgery (e.g., spinal surgery) and/or another medical procedure. In other embodiments, the scene 108 can be another type of scene. The sensor array 110 can further include dedicated object tracking hardware 113 (e.g., including individually identified trackers 113a-n) that captures positional data of one more objects, such as an instrument 101 (e.g., a surgical instrument or tool) having a tip 119, to track the movement and/or orientation of the objects through/in the scene 108. In some embodiments, the cameras 112 and the trackers 113 are positioned at fixed locations and orientations (e.g., poses) relative to one another. For example, the cameras 112 and the trackers 113 can be structurally secured by/to a mounting structure (e.g., a common frame) at predefined fixed locations and orientations. In some embodiments, the cameras 112 are positioned such that neighboring cameras 112 share overlapping views of the scene 108. In general, the position of the cameras 112 can be selected to maximize clear and accurate capture of all or a selected portion of the scene 108. Likewise, the trackers 113 can be positioned such that neighboring trackers 113 share overlapping views of the scene 108. Therefore, all or a subset of the cameras 112 and the trackers 113 can have different extrinsic parameters, such as position and orientation (e.g., pose).

In some embodiments, the cameras 112 in the sensor array 110 are synchronized to capture images of the scene 108 simultaneously (within a threshold temporal error). In some embodiments, all or a subset of the cameras 112 are light field, plenoptic, and/or RGB cameras that capture information about the light field emanating from the scene 108 (e.g., information about the intensity of light rays in the scene 108 and also information about a direction the light rays are traveling through space). In some embodiments, image data from the cameras 112 can be used to reconstruct a light field of the scene 108. More specifically, the cameras 112 can be RGB cameras that capture a combined image data set for reconstructing a light field of the scene 108. Therefore, in some embodiments the images captured by the cameras 112 encode depth information representing a surface geometry of the scene 108. In some embodiments, the cameras 112 are substantially identical. In other embodiments, the cameras 112 include multiple cameras of different types. For example, different subsets of the cameras 112 can have different intrinsic parameters such as focal length, sensor type, optical components, and the like. The cameras 112 can have charge-coupled device (CCD) and/or complementary metal-oxide semiconductor (CMOS) image sensors and associated optics. Such optics can include a variety of configurations including lensed or bare individual image sensors in combination with larger macro lenses, micro-lens arrays, prisms, and/or negative lenses. For example, the cameras 112 can be separate light field cameras each having their own image sensors and optics. In other embodiments, some or all of the cameras 112 can comprise separate microlenslets (e.g., lenslets, lenses, microlenses) of a microlens array (MLA) that share a common image sensor. In other embodiments, some or all of the cameras 112 can be RGB (e.g., color) cameras having visible imaging sensors that together provide a light field data set of the scene 108.

In some embodiments, the trackers 113 are imaging devices, such as infrared (IR) cameras that can capture images of the scene 108 from a different perspective compared to other ones of the trackers 113. Accordingly, the trackers 113 and the cameras 112 can have different spectral sensitives (e.g., infrared vs. visible wavelength). In some embodiments, the trackers 113 capture image data of a plurality of optical markers (e.g., fiducial markers, marker balls) in the scene 108, such as markers 111 coupled to the instrument 101.

In the illustrated embodiment, the sensor array 110 further includes a depth sensor 114. In some embodiments, the depth sensor 114 includes (i) one or more projectors 116 that project a structured light pattern onto/into the scene 108 and (ii) one or more depth cameras 118 (which can also be referred to as second cameras) that capture second image data of the scene 108 including the structured light projected onto the scene 108 by the projector 116. The projector 116 can project a speckled pattern or a pattern of dots, for example. The projector 116 and the depth cameras 118 can operate in the same wavelength and, in some embodiments, can operate in a wavelength different than the cameras 112. For example, the cameras 112 can capture the first image data in the visible spectrum, while the depth cameras 118 capture the second image data in the infrared spectrum. In some embodiments, the depth cameras 118 have a resolution that is less than a resolution of the cameras 112. For example, the depth cameras 118 can have a resolution that is less than 70%, 60%, 50%, 40%, 30%, or 20% of the resolution of the cameras 112. In other embodiments, the depth sensor 114 can include other types of dedicated depth detection hardware (e.g., a LiDAR detector) for determining the surface geometry of the scene 108. In other embodiments, the sensor array 110 can omit the projector 116 and/or the depth cameras 118.

In the illustrated embodiment, the processing device 102 includes an image processing device 103 (e.g., an image processor, an image processing module, an image processing unit), a registration processing device 105 (e.g., a registration processor, a registration processing module, a registration processing unit), a tracking processing device 107 (e.g., a tracking processor, a tracking processing module, a tracking processing unit), and a surgical characterization processing device 109 (e.g., a surgical characterization processor, a surgical characterization processing module, a surgical characterization processing unit, a surgical characterization generation device). The image processing device 103 can (i) receive the first image data captured by the cameras 112 (e.g., light field images, light field image data, RGB images) and depth information from the depth sensor 114 (e.g., the second image data captured by the depth cameras 118), and (ii) process the image data and depth information to synthesize (e.g., generate, reconstruct, render) a three-dimensional (3D) output image of the scene 108 corresponding to a virtual camera perspective (e.g., a novel camera perspective). The output image can correspond to an approximation of an image of the scene 108 that would be captured by a camera placed at an arbitrary position and orientation corresponding to the virtual camera perspective. In some embodiments, the image processing device 103 can further receive and/or store calibration data for the cameras 112 and/or the depth cameras 118 and synthesize the output image based on the image data, the depth information, and/or the calibration data. More specifically, the depth information and the calibration data can be used/combined with the images from the cameras 112 to synthesize the output image as a 3D (or stereoscopic 2D) rendering of the scene 108 as viewed from the virtual camera perspective. In some embodiments, the image processing device 103 can synthesize the output image using any of the methods disclosed in U.S. patent application Ser. No. 16/457,780, filed Jun. 28, 2019, and titled “SYNTHESIZING AN IMAGE FROM A VIRTUAL PERSPECTIVE USING PIXELS FROM A PHYSICAL IMAGER ARRAY WEIGHTED BASED ON DEPTH ERROR SENSITIVITY,” which is incorporated herein by reference in its entirety. In other embodiments, the image processing device 103 can generate the virtual camera perspective based only on the images captured by the cameras 112—without utilizing depth information from the depth sensor 114. For example, the image processing device 103 can generate the virtual camera perspective by interpolating between the different images captured by one or more of the cameras 112. In some embodiments, the image processing device 103 utilizes a neural radiance field (NeRF) rendering algorithm to synthesize and render an output image of the scene 108 based on RGB images captured by the cameras 112 and depth data captured by the depth sensor 114.

The image processing device 103 can synthesize the output image from images captured by a subset (e.g., two or more) of the cameras 112 in the sensor array 110, and does not necessarily utilize images from all of the cameras 112. For example, for a given virtual camera perspective, the processing device 102 can select a stereoscopic pair of images from two of the cameras 112. In some embodiments, such a stereoscopic pair can be selected to be positioned and oriented to most closely match the virtual camera perspective. In some embodiments, the image processing device 103 (and/or the depth sensor 114) estimates a depth for each surface point of the scene 108 relative to a common origin to generate a point cloud and/or a 3D mesh that represents the surface geometry of the scene 108. Such a representation of the surface geometry can be referred to as a surface reconstruction, a 3D reconstruction, a 3D surface reconstruction, a depth map, a depth surface, and/or the like. In some embodiments, the depth cameras 118 of the depth sensor 114 detect the structured light projected onto the scene 108 by the projector 116 to estimate depth information of the scene 108. In some embodiments, the image processing device 103 estimates depth from multiview image data from the cameras 112 using techniques such as light field correspondence, stereo block matching, photometric symmetry, correspondence, defocus, block matching, texture-assisted block matching, structured light, and the like, with or without utilizing information collected by the depth sensor 114. In other embodiments, depth may be acquired by a specialized set of the cameras 112 performing the aforementioned methods in another wavelength. In some embodiments, the image processing device 103 can generate a stereoscopic view by selecting images from a pair of the cameras 112 using any of the methods disclosed in U.S. patent application Ser. No. 17/521,235, filed Nov. 11, 2021, and titled “METHODS FOR GENERATING STEREOSCOPIC VIEWS IN MULTICAMERA SYSTEMS, AND ASSOCIATED DEVICES AND SYSTEMS,” which is incorporated herein by reference in its entirety.

In some embodiments, the registration processing device 105 receives and/or stores initial image data, such as image data of a three-dimensional volume of a patient (3D image data). The image data can include, for example, computerized tomography (CT) scan data, magnetic resonance imaging (MRI) scan data, ultrasound images, fluoroscope images, and/or other medical or other image data. The image data can be segmented or unsegmented. The registration processing device 105 can register the initial image data to the real time images captured by the cameras 112 and/or the depth sensor 114 by, for example, determining one or more transforms/transformations/mappings between the two. The processing device 102 (e.g., the image processing device 103) can then apply the one or more transformations to the initial image data such that the initial image data can be aligned with (e.g., overlaid on) the output image of the scene 108 in real time or near real time on a frame-by-frame basis, even as the virtual perspective changes. That is, the image processing device 103 can fuse the initial image data with the real time output image of the scene 108 to present a mediated-reality view that enables, for example, a surgeon to simultaneously view a surgical site in the scene 108 and the underlying 3D anatomy of a patient undergoing an operation. In some embodiments, the registration processing device 105 can register the initial image data to the real time images by using any of the methods disclosed in U.S. patent application Ser. No. 17/140,885, filed Jan. 4, 2021, and titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” and/or U.S. patent application Ser. No. 18/084,389, filed Dec. 19, 2022, and titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” each of which is incorporated by reference herein in its entirety.

In some embodiments, the tracking processing device 107 processes positional data captured by the trackers 113 to track objects (e.g., the instrument 101) within the vicinity of the scene 108. For example, the tracking processing device 107 can determine the position of the markers 111 in the 2D images captured by two or more of the trackers 113, and can compute the 3D position of the markers 111 via triangulation of the 2D positional data. More specifically, in some embodiments the trackers 113 include dedicated processing hardware for determining positional data from captured images, such as a centroid of the markers 111 in the captured images. The trackers 113 can then transmit the positional data to the tracking processing device 107 for determining the 3D position of the markers 111. In other embodiments, the tracking processing device 107 can receive the raw image data from the trackers 113. In a surgical application, for example, the tracked object can comprise a surgical instrument, an implant, a hand or arm of a physician or assistant, and/or another object having the markers 111 mounted thereto. In some embodiments, the processing device 102 can recognize the tracked object as being separate from the scene 108, and can apply a visual effect to the 3D output image to distinguish the tracked object by, for example, highlighting the object, labeling the object, and/or applying a transparency to the object.

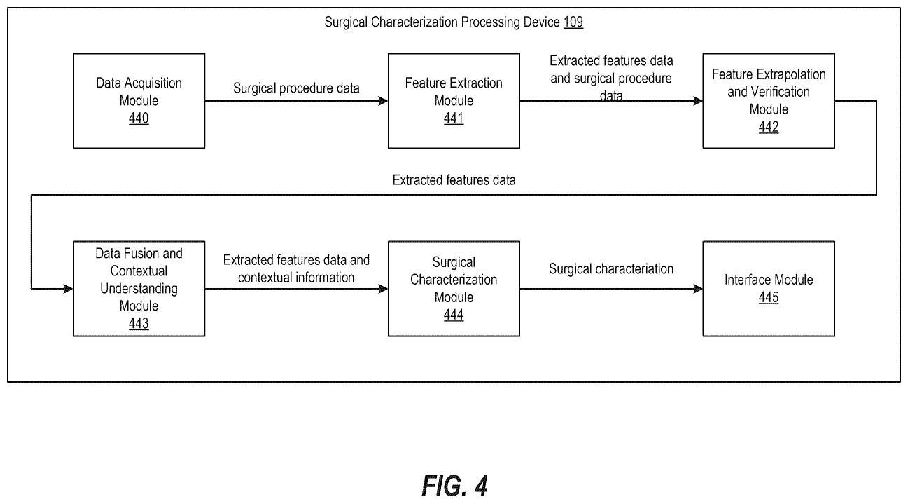

In some embodiments, the surgical characterization processing device 109 can receive, store, and/or acquire multi-modal data of a surgical procedure carried out within the scene 108 from the sensor array 110 and/or from other sources. The multi-modal data can comprise initial image data of a patient undergoing the surgical procedure, data captured by the cameras 112 of the surgical procedure, data captured by the trackers 113 of the surgical procedure, data captured by the depth sensor 114 of the surgical procedure, data processed by the image processing device 103 (e.g., a virtual view or composite image), data processed by the registration processing device 105 (e.g., a registration of initial image data to the patient), data processed by the tracking processing device 107 (e.g., instrument positional data, navigation data), and/or additional data generated before, during, and/or after the surgical procedure within the scene 108 that is relevant to the surgical procedure. The surgical characterization device 109 can automatically recognize context/features (e.g., surgical events) in data streams of different modalities and verify and extrapolate the context/features across all data streams to provide context to each of the data streams. The surgical characterization device 109 can further utilize one or more artificial intelligence (AI) applications (e.g., machine learning (ML) models) to intelligently process the various data streams and contextual data to automatically generate a detailed characterization of the surgical procedure, as described in further detail below with reference to FIG. 4-6.

In some embodiments, functions attributed to the processing device 102, the image processing device 103, the registration processing device 105, the tracking processing device 107, and/or the data processing device 109 can be practically implemented by two or more physical devices. For example, in some embodiments a synchronization controller (not shown) controls images displayed by the projector 116 and sends synchronization signals to the cameras 112 to ensure synchronization between the cameras 112 and the projector 116 to enable fast, multi-frame, multicamera structured light scans. Additionally, such a synchronization controller can operate as a parameter server that stores hardware specific configurations such as parameters of the structured light scan, camera settings, and camera calibration data specific to the camera configuration of the sensor array 110. The synchronization controller can be implemented in a separate physical device from a display controller that controls the display device 104, or the devices can be integrated together.

The processing device 102 can comprise a processor and a non-transitory computer-readable storage medium that stores instructions that when executed by the processor, carry out the functions attributed to the processing device 102 as described herein. Although not required, aspects and embodiments of the present technology can be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The present technology can be embodied in a special purpose computer or data processor that is specifically programmed, configured or constructed to perform one or more of the computer-executable instructions explained in detail below. Indeed, the term “computer” (and like terms), as used generally herein, refers to any of the above devices, as well as any data processor or any device capable of communicating with a network, including consumer electronic goods such as game devices, cameras, or other electronic devices having a processor and other components, e.g., network communication circuitry.

The present technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines can be located in both local and remote memory storage devices. Aspects of the present technology described below can be stored or distributed on computer-readable media, including magnetic and optically readable and removable computer discs, stored as in chips (e.g., EEPROM or flash memory chips). Alternatively, aspects of the present technology can be distributed electronically over the Internet or over other networks (including wireless networks). Those skilled in the relevant art will recognize that portions of the present technology can reside on a server computer, while corresponding portions reside on a client computer. Data structures and transmission of data particular to aspects of the present technology are also encompassed within the scope of the present technology.

The virtual camera perspective is controlled by an input controller 106 that can update the virtual camera perspective based on user driven changes to the camera's position and rotation. The output images corresponding to the virtual camera perspective can be outputted to the display device 104. In some embodiments, the image processing device 103 can vary the perspective, the depth of field (e.g., aperture), the focus plane, and/or another parameter of the virtual camera (e.g., based on an input from the input controller) to generate different 3D output images without physically moving the sensor array 110. The display device 104 can receive output images (e.g., the synthesized 3D rendering of the scene 108) and display the output images for viewing by one or more viewers. In some embodiments, the processing device 102 receives and processes inputs from the input controller 106 and processes the captured images from the sensor array 110 to generate output images corresponding to the virtual perspective in substantially real time or near real time as perceived by a viewer of the display device 104 (e.g., at least as fast as the frame rate of the sensor array 110).

Additionally, the display device 104 can display a graphical representation on/in the image of the virtual perspective of any (i) tracked objects within the scene 108 (e.g., a surgical instrument) and/or (ii) registered or unregistered initial image data. That is, for example, the system 100 (e.g., via the display device 104) can blend augmented data into the scene 108 by overlaying and aligning information on top of “passthrough” images of the scene 108 captured by the cameras 112 and/or generated by images captured by the cameras 112. Moreover, the system 100 can create a mediated-reality experience where the scene 108 is reconstructed using light field image data of the scene 108 captured by the cameras 112, and where instruments are virtually represented in the reconstructed scene via information from the trackers 113. Additionally or alternatively, the system 100 can remove the original scene 108 and completely replace it with a registered and representative arrangement of the initial image data, thereby removing information in the scene 108 that is not pertinent to a user's task.

The display device 104 can comprise, for example, a head-mounted display device, a monitor, a computer display, and/or another display device. In some embodiments, the input controller 106 and the display device 104 are integrated into a head-mounted display device and the input controller 106 comprises a motion sensor that detects position and orientation of the head-mounted display device. In some embodiments, the system 100 can further include a separate tracking system (not shown), such an optical tracking system, for tracking the display device 104, the instrument 101, and/or other components within the scene 108. Such a tracking system can detect a position of the head-mounted display device 104 and input the position to the input controller 106. The virtual camera perspective can then be derived to correspond to the position and orientation of the head-mounted display device 104 in the same reference frame and at the calculated depth (e.g., as calculated by the depth sensor 114) such that the virtual perspective corresponds to a perspective that would be seen by a viewer wearing the head-mounted display device 104. Thus, in such embodiments the head-mounted display device 104 can provide a real time rendering of the scene 108 as it would be seen by an observer without the head-mounted display device 104. Alternatively, the input controller 106 can comprise a user-controlled control device (e.g., a mouse, pointing device, handheld controller, gesture recognition controller) that enables a viewer to manually control the virtual perspective displayed by the display device 104.

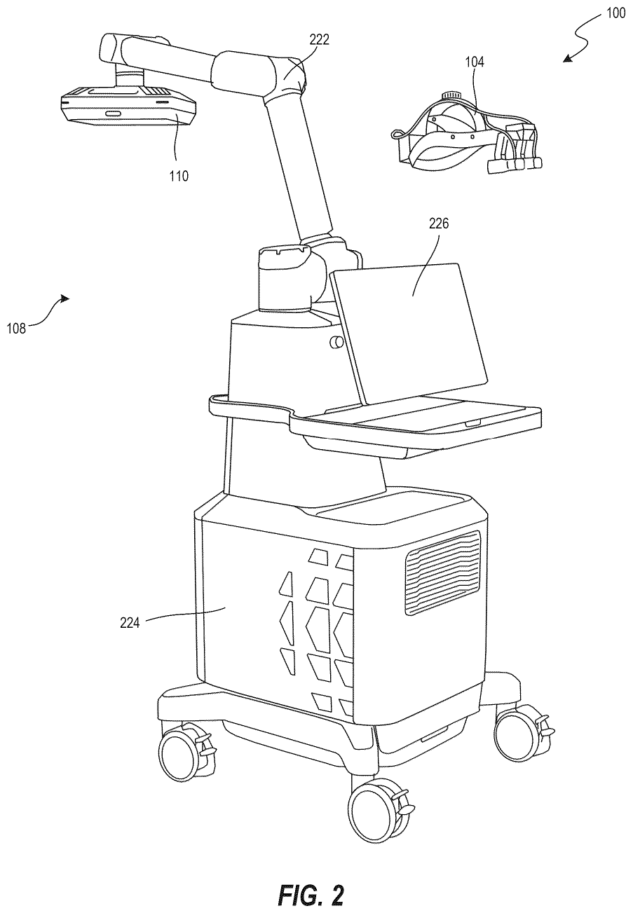

FIG. 2 is a perspective view of an environment (e.g., a surgical environment) employing the system 100 (e.g., for a surgical application) in accordance with embodiments of the present technology. In the illustrated embodiment, the sensor array 110 is positioned over the scene 108 (e.g., a surgical site) and supported/positioned via a mover 222 that is operably coupled to a workstation 224. In some embodiments, the mover 222 is manually movable to position the sensor array 110 while, in other embodiments, the mover 222 is robotically controlled in response to the input controller 106 (FIG. 1) and/or another controller. Accordingly, the mover 222 can be referred to as a robotic mover, a robotic arm, a robotically-controlled arm, and/or the like. The mover 222 allows the sensor array 110 to be precisely moved relative to the scene 108 such that the sensor array 110 is mobile relative to the scene 108.

In the illustrated embodiment, the display device 104 is a head-mounted display device (e.g., a virtual reality headset, augmented reality headset). The workstation 224 can include a computer to control various functions of the processing device 102, the display device 104, the input controller 106, the sensor array 110, and/or other components of the system 100 shown in FIG. 1. Accordingly, in some embodiments the processing device 102 and the input controller 106 are each integrated in the workstation 224. In some embodiments, the workstation 224 includes a secondary display 226 that can display a user interface for performing various configuration functions, a mirrored image of the display on the display device 104, and/or other useful visual images/indications. In other embodiments, the system 100 can include more or fewer display devices. For example, in addition to (or alternatively to) the display device 104 and the secondary display 226, the system 100 can include another display (e.g., a medical grade computer monitor) visible to the user wearing the display device 104.

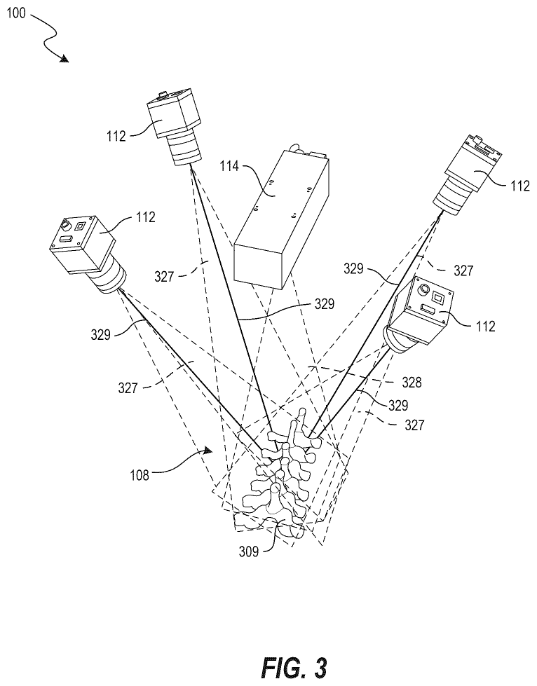

FIG. 3 is an isometric view of a portion of the system 100 illustrating four of the cameras 112 in accordance with embodiments of the present technology. Other components of the system 100 (e.g., other portions of the sensor array 110, the processing device 102, etc.) are not shown in FIG. 3 for the sake of clarity. In the illustrated embodiment, each of the cameras 112 has a field of view 327 and a focal axis 329. Likewise, the depth sensor 114 can have a field of view 328 aligned with a portion of the scene 108. The cameras 112 can be oriented such that the fields of view 327 are aligned with a portion of the scene 108 and at least partially overlap one another to together define an imaging volume. In some embodiments, some or all of the field of views 327, 328 at least partially overlap. For example, in the illustrated embodiment the fields of view 327, 328 converge toward a common measurement volume including a portion of a spine 309 of a patient (e.g., a human patient) located in/at the scene 108. In some embodiments, the cameras 112 are further oriented such that the focal axes 329 converge to a common point in the scene 108. In some aspects of the present technology, the convergence/alignment of the focal axes 329 can generally maximize disparity measurements between the cameras 112. In some embodiments, the cameras 112 and the depth sensor 114 are fixedly positioned relative to one another (e.g., rigidly mounted to a common frame) such that a relative positioning of the cameras 112 and the depth sensor 114 relative to one another is known and/or can be readily determined via a calibration process. In other embodiments, the system 100 can include a different number of the cameras 112 and/or the cameras 112 can be positioned differently relative to another.

Referring to FIG. 1-3 together, in some aspects of the present technology the system 100 can generate a digitized view of the scene 108 that provides a user (e.g., a surgeon) with increased “volumetric intelligence” of the scene 108. For example, the digitized scene 108 can be presented to the user from the perspective, orientation, and/or viewpoint of their eyes such that they effectively view the scene 108 as though they were not viewing the digitized image (e.g., as though they were not wearing the head-mounted display 104). However, the digitized scene 108 permits the user to digitally rotate, zoom, crop, or otherwise enhance their view to, for example, facilitate a surgical workflow. Likewise, initial image data, such as CT scans and/or MRI data, can be registered to and overlaid over the image of the scene 108 to allow a surgeon to view these data sets together. Such a fused view can allow the surgeon to visualize aspects of a surgical site that may be obscured in the physical scene 108—such as regions of bone and/or tissue that have not been surgically exposed.

### II. Selected Embodiments of Systems and Methods for Verifying Surgical Events Across Data Streams and Automatically Generating a Characterization of a Surgical Procedure

Referring to FIG. 1-3, the sensor array 110 can capture and/or generate robust, multi-modal data of a surgical procedure such as image data, instrument tracking data (e.g., navigation data), registration data, alignment data, depth data, and/or the like in real time or near real time over the course of a surgical procedure. The surgical characterization processing device 109 can process some or all of the collected data, and optionally data from sources other than sensor array 110, to automatically recognize context/features (e.g., surgical events) in different data modalities and verify the context/features across all data modalities to provide context to each of the data modalities. The surgical characterization device 109 can further utilize one or more artificial intelligence (AI) applications (e.g., machine learning (ML) models) to intelligently process the various data streams and contextual data to automatically generate a detailed characterization of the surgical procedure.

FIG. 4 is a block diagram of the surgical characterization processing device 109 of FIG. 1 in accordance with embodiments of the present technology. In general, the surgical characterization processing device 109 is configured to automatically generate a detailed and accurate characterization of a surgical procedure carried out on a patient by leveraging multi-modal data captured and/or generated by the sensor array 110 of FIG. 1 and/or from data sources other than the sensor array 110. The characterization can comprise, for example, a detailed and accurate operative note of the surgical procedure as described in detail in U.S. Provisional Patent Application No. 63/642,440, filed May 3, 2024, and titled “METHODS AND SYSTEMS FOR AUTOMATICALLY GENERATING A SURGICAL OPERATIVE NOTE,” which is incorporated herein by reference in its entirety and attached hereto as Appendix A, and U.S. Provisional Patent Application filed Sep. 6, 2024, identified by attorney docket number 13442.8032.US01, and titled “METHODS AND SYSTEMS FOR AUTOMATICALLY GENERATING A SURGICAL OPERATIVE NOTE,” which is also incorporated herein by reference in its entirety and attached hereto as Appendix B. In the illustrated embodiment, the surgical characterization device 109 includes a data acquisition module 440, a feature extraction module 441, a feature extrapolation and verification module 442, a contextual understanding module 443, a surgical characterization module 444, and an interface module 445 (collectively modules 440-445). The modules 440-445 cooperate to perform a method of automatically generating a characterization of the surgical procedure.

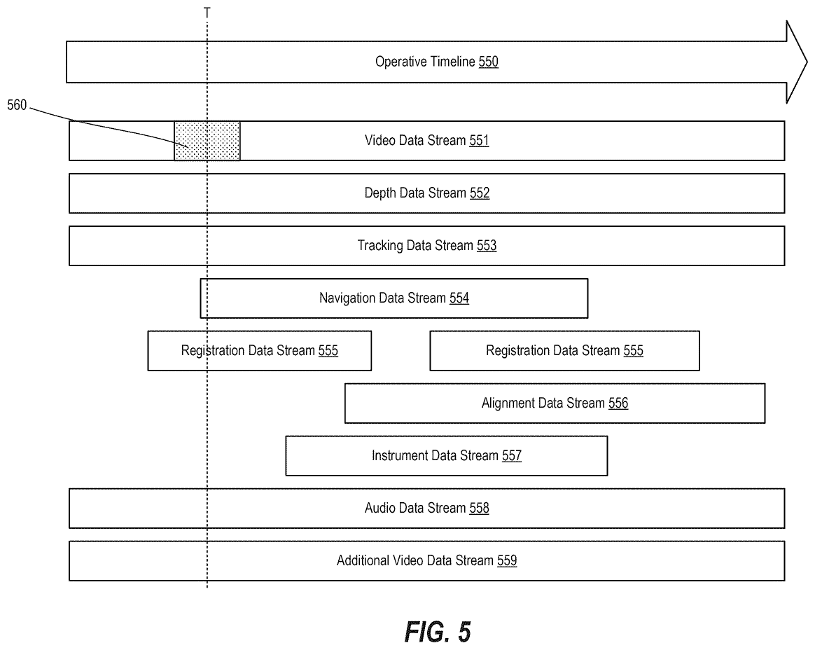

The data acquisition module 440 can receive, acquire, record, and/or store many modalities (e.g., forms) of data related to the surgical procedure carried out on a patient, such as a spinal surgical procedure, a general surgical procedure, an orthopedic surgical procedure, a neurosurgical procedure, a laparoscopic procedure, etc. FIG. 5, for example, is a schematic illustration of different modalities of intraoperative data streams that the data acquisition module 440 can acquire, record, and/or store over an operative timeline 550 of the surgical procedure in accordance with embodiments of the present technology. In the illustrated embodiment, the intraoperative data includes a video data stream 551, a depth data stream 552, a tracking data stream 553, a navigation data stream 554, a registration data stream 555, an alignment data stream 556, an instrument data stream 557, an audio data stream 558, and an additional video data stream 559.

Referring to FIGS. 1 and 5, the video data stream 551 can comprise video data (e.g., RGB video data) received from the cameras 112, the depth data stream 552 can comprise depth data received from the depth sensor 114, and the tracking data stream 553 can comprise instrument tracking data received from the trackers 113. Accordingly, the data acquisition module 440 can receive the data streams 551-553 directly from the sensor array 110.

Additionally, the data acquisition module 440 can receive data processed by the image processing device 103, the registration processing device 105, the tracking processing device 107, and/or other processing devices of the sensor array 110 or communicatively coupled to the sensor array 110. For example, the navigation data stream 554 can comprise a synthetic video stream of the surgical procedure generated by the image processing device 103 based on multiple video streams from the cameras 112, and the registration data stream 555 can include registration data generated by the registration processing device 105. Similarly, the alignment data stream 556 can comprise alignment data generated by the sensor array 110 related to the pose, orientation, position, etc., of a surgical target. For example, the alignment data can comprise data related to the alignment of a spine (e.g., one or more angles) when the surgical procedure is a spinal surgical procedure. The alignment data can be of the type, and can be generated by the sensor array 110, as described in U.S. Pat. No. 12,011,227, filed May 3, 2022, and titled “METHODS AND SYSTEMS FOR DETERMINING ALIGNMENT PARAMETERS OF A SURGICAL TARGET, SUCH AS A SPINE,” which is incorporated by reference herein in its entirety.

The data acquisition module 440 can further receive data streams from sources other than sensor array 110. For example, referring to FIG. 5, the instrument data stream 557 can comprise data from an endoscope, exoscope, and/or other surgical instrument. Likewise, the audio data stream 558 can comprise audio data from a microphone positioned to record sounds of the surgical procedure. In some embodiments, the microphone is located onboard the sensor array 110 (FIG. 1). The additional video data stream 559 can comprise video data from one or more additional cameras positioned to view the surgical procedure.

The multiple different data streams 551-559 can be timestamped together across the operative timeline 550. The different data streams 551-559 can also include continuous data over the entire operative timeline 550, or can include intermittent data recorded for only parts of the operative timeline 550. For example, the data streams 551-553 can be received continuously from the sensor array 110 (FIG. 1) over the entire operative timeline 550, while the data streams 554-557 are intermittent. For example, registration data may only be available for certain portions of the operative timeline, such as after a surgeon surgically exposes a vertebra to allow for registration thereto, such that the registration data stream 555 is only generated for certain portions of the operative timeline 550. Likewise, instrument data from an endoscope, exoscope, and/or other surgical instrument may only be generated when that instrument is in use during the surgical procedure such that the instrument data stream 557 is only generated for certain portions of the operative timeline 550.

Referring to FIG. 4, in addition to intraoperative data such as that described in detail with reference to FIG. 5, the data acquisition module 440 can receive other types of data such as (i) initial image data of the patient (e.g., computerized tomography (CT) images, magnetic resonance imaging (MRI) images and/or the like acquired preoperatively, during, or shortly before the surgical procedure), (ii) surgical navigation and planning data, (iii) log data, (iv) electronic health records (EHRs) of the patient, (v) surgical instrument data (e.g., kind, size, type), and/or (vi) the like. The data acquired by the data acquisition module 440, whether video data, preoperative imaging data, log data, etc., can be referred to as “surgical procedure data. ” In some embodiments, the surgical procedure data is stored in a digital format for further processing by the surgical characterization processing device 109.

The feature extraction module 441 can analyze the surgical procedure data to extract (e.g., recognize) relevant features, including surgical actions, anatomical landmarks, instruments and objects, instrument and object movements, and/or intraoperative events. Such features provide context to the surgical procedure data—for example, that a specific action has occurred, that a specific anatomical landmark is visible, and so on. Accordingly, the extraction of “features” can be referred to as the extraction, determination, identification, etc., of “context” of the surgical procedure data. In some embodiments, the feature extraction module 441 utilizes computer vision techniques such as object detection, motion tracking, and/or image segmentation to identify and extract features from the surgical procedure video data. Referring to FIGS. 4 and 5, in some embodiments the feature extraction module 441 identifies and extracts features from non-video streams of the surgical procedure data such as the navigation data stream 554, the registration data stream 555, the alignment data stream 556, the audio data stream 558, etc. Features that can be extracted from the video data can include (i) surgical actions such as blunt dissection, deep dissection, incision, closure, laminotomy, etc., (ii) anatomical landmarks such as vertebrae, spinous processes, inter-spinous ligaments, lamina, pars and facets, etc., (iii) instruments, objects, hardware, tools, implants, etc., (iv) instrument and object movements such as pedicle screw entry, cutting instrument usage, retractor usage, etc., and/or (v) intraoperative events such as registration, incision, dissection, closure, registration, etc. For example, referring to FIGS. 4 and 5, the feature extraction module 441 can utilize registration data from the registration data stream 555 to determine a particular anatomical target (e.g., vertebra or vertebrae) that is being operated on at a particular time along the operative timeline 550. Likewise, in some embodiments, the feature extraction module 441 utilizes tracking data from the tracking data stream 553 to recognize instrument movements, and can compare video data from the video data stream 551, the instrument data stream 557, and/or the additional video data stream 559 to determine corresponding surgical actions and intraoperative events. For example, if a cutting instrument is recognized as approaching the anatomy of the patient in the tracking data stream 553, the feature extraction module 442 can analyze the corresponding video data from the video data stream 551 to determine a corresponding surgical action (e.g., dissection, laminotomy) and/or intraoperative event (e.g., incision, dissection).

The outputs of the feature extraction module 441 can be portions of the surgical procedure data that correspond to an identified feature/object, such as video frames (e.g., video snippets, video segments), preoperative images, surgical navigation data, etc. For example, when the feature extraction module 441 identifies a dissection in the surgical procedure data, the feature extraction module 441 can output an image of the dissection from a single video frame, and/or can output a video segment showing the incision being made. Likewise, where the feature extraction module 441 identifies a laminotomy in the surgical procedure data, the feature extraction module 441 can output an image of the completed laminotomy, a video segment showing the laminotomy being carried out, a preoperative image of the vertebra before the laminotomy, data about an instrument identified as used to carry out the laminotomy, etc.

A feature recognized in one data stream may not be independently recognizable/identifiable in a different data stream. For example, an anatomical target extracted from the registration data stream 555 may not be automatically identifiable in the video data stream 551. As one example, a spinal surgical procedure may include surgically exposing a portion of a patient's vertebra. However, which vertebra (e.g., L5) is surgically exposed may not be recognizable/determinable in the video data stream 551 (and/or other ones of the data streams 552-554 and 556-559) of the spinal surgical procedure without additional information because the video data stream 551 does not include enough detail to allow for the identification of the particular vertebra due to the structural similarity of different vertebrae, partial occlusion of the vertebra, etc. That is, the feature extraction module 441 cannot identify and extract the particular anatomical target (e.g., L5 vertebra) from the video data stream 551 alone.

Accordingly, referring to FIG. 4, the feature extrapolation and verification module 442 can extrapolate and verify features identified in/extracted from one data modality across some or all of the other different data modalities. That is, the feature extrapolation and verification module 442 can provide contextual information to a data stream based on contextual information determined in another data stream. For example, referring to FIGS. 4 and 5, the feature extrapolation and verification module 442 can receive, from the feature extraction module 441, the extracted feature of a specific identified anatomical target (e.g., L5 vertebra) in the registration data stream 555 at a specific time T (FIG. 5) along the operative timeline 550. The feature extrapolation and verification module 442 can then identify and extract the same feature in the other data streams 551-554 and 556-559 because the data streams 551-559 are timestamped together along the operative timeline 550. That is, the feature extrapolation and verification module 442 can identify that the anatomical target being operated on in the video data stream 551 is the same as the anatomical target identified in the registration data stream 555. The extracted feature (e.g., specific anatomical target) provides an anchor point of knowledge (e.g., ground truth about a particular aspect occurring in the surgical procedure) along the operative timeline 550 that serves to inform and verify other data streams in which the extracted feature could not otherwise be identified.

The feature extrapolation and verification module 442 can further determine that an extracted feature from a specific time in one data stream corresponds to a region in time forward and/or backward of the specific time in another data stream. For example, referring to FIG. 5, the feature extrapolation and verification module 442 can determine that the extracted feature of a specific identified anatomical target (e.g., L5 vertebra) in the registration data stream 555 at the specific time T (FIG. 5) along the operative timeline 550 provides context to a certain time span 560 of the video data stream 551 around the time T. For example, the feature extrapolation and verification module 442 can determine that the anatomical target visible in the video data stream 551 during the time span 560 is the same as that identified in the registration data at the time T—for example, the L5 vertebra.

Accordingly, in some aspects of the present technology, the feature extrapolation and verification module 442 verifies features identified in one intraoperative data stream across all intraoperative data streams. The identified features serve as anchor points that anchor the knowledge of the system 100 (FIG. 1) across all data streams. That is, a feature identified in one data stream can provide context to all other data streams that might not being automatically extractable from the other data streams without additional information. The outputs of the feature extrapolation and verification module 442 can be portions of the surgical procedure data that correspond to an identified feature, such as video frames (e.g., video snippets, video segments), preoperative images, surgical navigation data, etc. Notably, referring to FIGS. 4 and 5, because of the verification and extrapolation of identified features across different data streams, the outputs of the feature extrapolation and verification module 442 can comprise portions of any of the intraoperative data streams 551-559, regardless of whether the feature was independently identifiable in the given one of the intraoperative data streams. That is, for example, the feature extrapolation and verification module 442 can output a video segment (e.g., for the time span 560) or image (e.g., at the time T) from the video data stream 551 that corresponds to the anatomical target identified in the registration data stream 555, despite the anatomical target not being independently identifiable in the video data stream 551 at the time T.

Referring to FIG. 4, the data fusion and contextual understanding module 443 can receive the extracted features as a data stream from the feature extrapolation and verification module 442 and integrate the extracted features from multiple data modalities to provide further context and temporal understanding of the surgical procedure. For example, the data fusion and contextual understanding module 443 can group the same feature recognized in different modalities of the surgical procedure data (e.g., the intraoperative data streams 551-559 of FIG. 5) together to provide a temporal understanding of the surgical procedure. As one example, referring to FIGS. 4 and 5, the data fusion and contextual understanding module 443 can group together an extracted video segment of a laminotomy captured in the video data stream 551, extracted depth information of the vertebra before, during, and/or after the laminotomy from the depth data stream 552, extracted surgical instrument data from the tracking data stream 553 (e.g., the type of instrument used to carry out the laminotomy, its position/trajectory during the laminotomy, etc.), extracted navigation information during the laminotomy from the navigation data stream 554, a preoperative image of the vertebra before the laminotomy, etc. In some embodiments, such grouping of features is based on the extrapolation and verification of features performed by the feature extrapolation and verification module 442. For example, the data fusion and contextual understanding module 443 can group together extracted portions of the data streams 551-559 at and/or around the time T based on the anatomical target identified in the registration data stream 555.

The data fusion and contextual understanding module 443 can also provide additional contextual information/data based on the extracted features to provide context to the surgical procedure. For example, the data fusion and contextual understanding module 443 can utilize an artificial intelligence (AI) application (e.g., a generative AI application, a generative AI model, a large language model (LLM), and/or the like) that receives as inputs one or more of the extracted features and/or additional surgical procedure data such as EHRs (e.g., including patient demographics, surgical indications, and preoperative assessments), preoperative images, and/or the like and that outputs additional contextual information about the surgical procedure. For example, EHR data including patent symptoms and preoperative images can inform the AI application about what surgical procedure would most likely be adopted for the particular surgical procedure carried out. As a more specific example, for a spinal surgical procedure, a preoperative CT image of the patient that reveals past L3-L4 fusion along with the knowledge of symptoms such as lumbar pain radiating bilaterally can inform the model that among the likely surgical procedures performed could be Revision L3-L5 Posterior Spinal Instrumented Fusion (Revision PSIF). Such contextual information can be added to the various extracted features—for example, that a video snippet of an incision and retraction in the patient is to access the L3-L5 vertebrae for fusion.

Referring to FIG. 4, the surgical characterization module 444 can receive the fusion of extracted features and contextual information from the data fusion and contextual understanding module 443 and utilize an AI application to convert the extracted features and contextual information into, for example, one or more natural language descriptions characterizing the surgical procedure. In some embodiments, the AI application is a natural language processing (NLP) algorithm that utilizes machine learning to convert video, contextual (e.g., feature) data, and other data to natural language text data. The outputs of the surgical characterization module 444 is a structured and coherent characterization of the surgical procedure. For example, the output can be an operative note of the surgical procedure that summarizes the surgical procedure, including the type of surgery performed, specific surgical techniques used, intraoperative findings, and/or postoperative care instructions. Additionally or alternatively, the output can be a performance characterization of the surgeon during the surgical procedure and/or another characterization of one or more aspects of the surgical procedure.

In some embodiments, the interface module 445 receives the surgical characterization and is configured to interface with one or more clinical health care systems, financial systems, and/or the like (e.g., third party systems and/or applications). For example, the surgical characterization processing device 109 can store the generated surgical characterization—and the surgical characterizations generated for multiple surgical procedures—and can be configured to interface with the one or more clinical health care systems, financial systems, and/or the like to provide a given final surgical characterization upon request. In some embodiments, the interface module 445 interfaces and/or comprises an application programming interface (API) that can receive API calls/requests from the one or more clinical health care systems, financial systems, and/or the like to provide a given surgical characterization for a particular surgical procedure. For example, financial systems such as revenue cycle management (RCM) systems, billing systems, insurance systems, and/or the like may request a surgical characterization in order to verify the medical necessity of the surgical procedure, ensure appropriate coding, calculate the reimbursement amount based on established fee schedules or reimbursement rates, etc. Likewise, clinical health care systems such as hospital systems, medical school systems, and/or the like may request a surgical characterization to inform ongoing postoperative care for the patient, provide teaching and learning opportunities, etc.

Referring to FIGS. 1 and 4, the surgical characterization processing device 109 can be installed in the system 100 and configured to run/operate within the system 100 without a connection to the internet, an external cloud application, and/or the like. That is, the surgical characterization processing device 109 can be positioned local to (e.g., integrated within) the system 100. In other embodiments, the surgical characterization processing device 109 can be deployed in a cloud computing environment and connected to the system 100 through an internet connection, such as a secure internet connection with sufficient bandwidth. That is, the surgical characterization processing device 109 can be positioned remote from the system 100. Additionally, the surgical characterization processing device 109 can receive the surgical procedure data (e.g., from the system 100) in real time or near real time and immediately process the surgical procedure data to generate the surgical characterization. In other embodiments, the surgical characterization processing device 109 can store the surgical procedure data as it is collected during the surgical procedure and/or receive the surgical procedure data after it has been collected during the surgical procedure. Then, after receipt of a user input or instruction after the surgical procedure is complete, the surgical characterization processing device 109 can process the surgical procedure data to generate the surgical characterization.

The various modules 440-445 of the surgical characterization processing device 109 operate together to carry out a method for automatically generating a surgical characterization. The various modules 440-445 can be combined, implemented in the same or separate computing environments and/or in the same or different computing device, ordered differently, and/or selectively omitted.

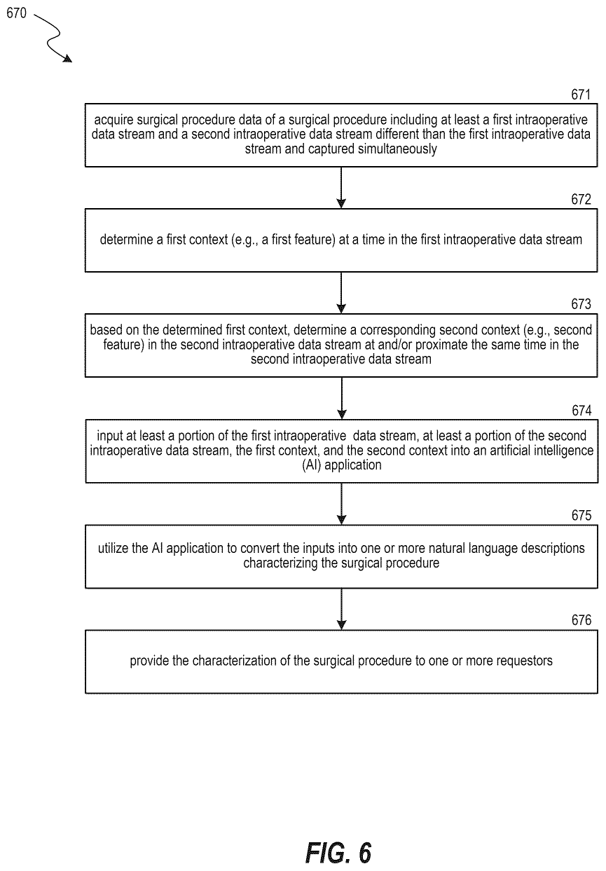

FIG. 6 is a flow diagram of a process or method 670 carried out by the surgical characterization processing device 109 for automatically generating a surgical characterization in accordance with embodiments of the present technology. Although some features of the method 670 are described in the context of the embodiments shown in FIG. 1-5 for the sake of illustration, one skilled in the art will readily understand that the method 670 can be carried out using other suitable systems and/or devices described herein.

At block 671, the method 670 can include acquiring surgical procedure data of a surgical procedure including at least a first intraoperative data stream and a second intraoperative data stream different than the first intraoperative data stream and captured simultaneously. For example, as described in detail above with reference FIGS. 4 and 5, the data acquisition module 440 can acquire, receive, store, etc., multi-modal intraoperative data of the surgical procedure including image, video, text, and/or other data captured intraoperatively (e.g., any of the data streams 551-559). In some embodiments, the first intraoperative data stream is the registration data stream 555 and the second intraoperative data stream is the video data stream 551. The surgical procedure data can be acquired in real time or near real time during the surgical procedure, or can be received in full after completion of the surgical procedure. In some embodiments, the surgical procedure data can further include data captured preoperatively, such as preoperative CT and/or MRI images.

At block 672, the method 670 can include determining a first context (e.g., a first feature) at a time in the first intraoperative data stream. As described in detail above with reference to the feature extraction module 441 of FIG. 4, the first context can comprise surgical actions (e.g., blunt dissection, deep dissection, incision, closure, laminotomy), anatomical targets (e.g., vertebrae, spinous processes, inter-spinous ligaments, lamina, pars and facets), instrument movements (e.g., pedicle screw entry, cutting instrument usage, retractor usage), and/or intraoperative events (e.g., registration, incision, dissection, closure). For example, referring to FIG. 5, when the first intraoperative data stream comprises the registration data stream 555, block 672 can include determining an anatomical target in the registration data at the time T, such as the registration of a particular vertebra (e.g., the L5 vertebra) when the surgical procedure is a spinal surgical procedure.

At block 673, the method 670 can include determining a corresponding second context (e.g., second feature) in the second intraoperative data stream at and/or proximate the same time in the second intraoperative data stream based on the determined first context. As described in detail above with reference to the feature extrapolation and verification module 442 of FIG. 4, the first context may not be independently recognizable in the second intraoperative data stream based on the information in the second intraoperative data stream. For example, referring to FIG. 5, an anatomical target extracted from the registration data stream 555 may not be identifiable in the video data stream 551 because the video data stream 551 does not include enough detail to allow for the identification of the particular anatomical target. Accordingly, determining the second context in the second intraoperative data stream can comprise utilizing the first context as an anchor point along the operative timeline 550 to determine the second context. For example, where the first context is a particular anatomical target, the determined second context can comprise the particular anatomical target in the second intraoperative data stream. More specifically, the second context can include an identification of the particular anatomical target in the second intraoperative data stream at the same time T and/or in the time span 560 forward and/or backward of the same time T. Accordingly, context is generated for the second intraoperative data stream at and/or proximate the time T that would not be determinable from the second intraoperative data stream alone.

At block 674, the method 670 can include inputting at least a portion of the first intraoperative data stream, at least a portion of the second intraoperative data stream, the first context, and the second context into an AI application. At block 675, the method 670 can include utilizing the AI application to convert the inputs into one or more natural language descriptions of the surgical procedure. For example, as described in detail above with reference to the surgical characterization module 444 of FIG. 4, the AI application can be a natural language processing (NLP) algorithm that utilizes machine learning to convert video, contextual (e.g., feature) data, and other data to natural language text data. The surgical characterization is a structured and coherent characterization of the surgical procedure. For example, the surgical characterization can be an operative note of the surgical procedure that summarizes the surgical procedure, including the type of surgery performed, specific surgical techniques used, intraoperative findings, and/or postoperative care instructions. Additionally or alternatively, the surgical characterization can be a performance characterization of the surgeon during the surgical procedure and/or another characterization of one or more aspects of the surgical procedure.

Finally, at block 675, the method 670 can include providing the surgical characterization to one or more requestors. For example, as described in detail above with reference to the interface module 445 of FIG. 4, the method 670 can include providing the surgical characterization to one or more (i) clinical health care systems for continued patient care, learning, training, etc., (ii) financial systems for verifying the medical necessity of the surgical procedure, ensuring appropriate coding, calculating the reimbursement amount based on established fee schedules or reimbursement rates, etc., and/or (iii) other interested parties (e.g., third party systems and/or applications).

While the method 670 generally describes the identification of only a first context in a first intraoperative data stream (block 672) and a second context in a second intraoperative data stream (block 673), the method 670 can include identifying many contexts (e.g., features) in more than one intraoperative data stream and verifying/extrapolating those contexts across the multiple intraoperative data streams to generate a robust data set of the surgical procedure. The AI application can receive as inputs all or a subset of the intraoperative data streams and the identified contexts (block 674) and convert those inputs into the one or more natural language descriptions characterizing the surgical procedure (block 675).

Referring to FIG. 1-6, in some aspects of the present technology the surgical characterization processing device 109 can automatically generate an accurate surgical characterization describing a surgical procedure by leveraging multi-modal intraoperative data streams in a manner that provides improved efficiency, accuracy, standardization, and documentation compared to any manual method for describing/characterizing a surgical procedure. Notably, the present technology can recognize context/features in intraoperative data streams having different modalities, and accurately verify and extrapolate the context/features across all data streams. That is, context/features recognized in one data stream that may not be identifiable in other data streams can be used as anchor points of system knowledge to extrapolate and integrate the context/features into the other data streams. Such verification and extrapolation of context/features across all data streams provides a robust data set for input to an AI algorithm for generating the surgical characterization that would not be possible by extracting context/features independently in each data stream.

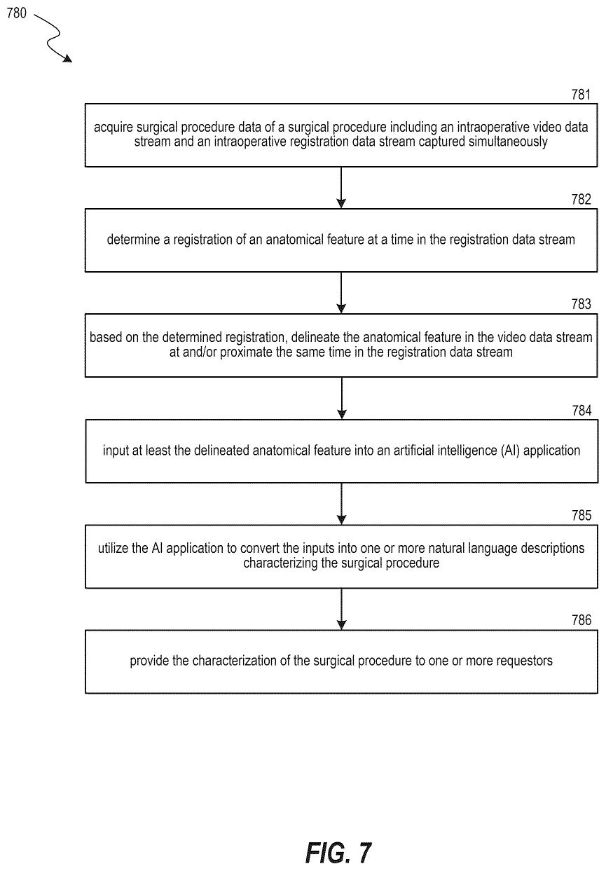

FIG. 7 is a flow diagram of a process or method 780 that can be carried out by the surgical characterization processing device 109 of FIG. 1 in accordance with additional embodiments of the present technology. Although some features of the method 670 are described in the context of the embodiments shown in FIG. 1-5 for the sake of illustration, one skilled in the art will readily understand that the method 670 can be carried out using other suitable systems and/or devices described herein. Likewise, the method 780 can include several features generally similar or identical to the features of the method 670 described in detail above with reference to FIG. 6.

At block 781, the method 780 can include acquiring surgical procedure data of a surgical procedure including a video data stream and a registration data stream captured simultaneously. For example, as described in detail above with reference FIGS. 4 and 5, the data acquisition module 440 can acquire, receive, store, etc., the registration data stream 555 and the video data stream 551. The surgical procedure data can be acquired in real time or near real time during the surgical procedure, or can be received in full after completion of the surgical procedure. Block 781 can be a more specific example of block 671 of the method 670 described in detail above with reference to FIG. 6.

At block 782, the method 780 can include determining a registration of an anatomical feature (e.g., a specific context) in the registration data stream. The determined registration can be the registration of initial image data (e.g., CT and/or MRI data) of the anatomical feature to the intraoperative video data stream during the surgical procedure. For example, as described in detail above with reference to FIG. 1, the registration processing device 105 can register the initial image data to the intraoperative video data stream by using any of the methods disclosed in U.S. patent application Ser. No. 17/140,885, filed Jan. 4, 2021, and titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” and/or U.S. patent application Ser. No. 18/084,389, filed Dec. 19, 2022, and titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” each of which is incorporated by reference herein in its entirety. Block 782 can be a more specific example of block 672 of the method 670 described in detail above with reference to FIG. 6.

As described in detail above, the anatomical feature may not be independently recognizable in the intraoperative video data stream. For example, a spinal surgical procedure may include surgically exposing a portion of a patient's vertebra. However, which vertebra (e.g., L5) is surgically exposed may not be recognizable/determinable in the intraoperative video data stream of the spinal surgical procedure without additional information because the video data stream does not include enough detail to allow for the identification of the particular vertebra due to the structural similarity of different vertebrae, partial occlusion of the vertebra, etc. Accordingly, at block 783 the method 780 can include, based on the determined registration, delineating the anatomical feature in the video data stream (e.g., determining a specific context) at and/or proximate the same time in the registration data stream. The registration of the anatomical feature between the initial image data and the intraoperative video data stream can be highly accurate, such as within 1 millimeter or less, within 3 millimeters or less, and/or the like. Accordingly, the registration data stream can provide highly accurate information about the location, orientation, and/or boundaries of the anatomical feature within the intraoperative video data stream.

In some aspects of the present technology, the high accuracy of the registration allows the video data stream to be contextualized on a pixel-by-pixel and/or voxel-by-voxel basis. For example, delineating the anatomical feature in the video data stream can include labeling, segmenting, outlining, cutting, cropping, highlighting, etc., the anatomical feature in the video data stream on a pixel-by-pixel and/or voxel-by-voxel basis. For example, where the anatomical feature is a specific vertebra, the registration of the initial image data to the video data stream can allow for labeling of the various pixels/voxels of the video data stream as corresponding to the specific vertebra or not. Alternatively or additionally to labeling, the pixels/voxels corresponding to the specific vertebra can be cropped and/or segmented from the video data stream. The anatomical feature can comprise multiple features, such as multiple vertebrae, nerve roots, spinal cord, etc., indicated as registered in the registration data stream. Thus, pixels/voxels of the intraoperative video data stream can be delineated as corresponding to a first vertebra, a second vertebra, a nerve root, etc. Accordingly, the registration data stream provides an anchor point of knowledge about accurate positioning of the anatomical feature in the video data stream along the timeline of the surgical procedures that serves to inform and verify the video data stream in which the anatomical feature could not otherwise be identified. Block 783 can be a more specific example of block 673 of the method 670 described in detail above with reference to FIG. 6.

Blocks 784-786 can be generally similar or identical to blocks 674-676 of the method 670 of FIG. 6, respectively. For example, at least the delineated anatomical feature can be input into an AI application (block 784), the AI application can convert the inputs into one or more natural language descriptions of the surgical procedure (block 785), and the surgical characterization can be provided to one or more requestors (block 786). Blocks 784-786 are optional and, in some embodiments, the method 780 can end at block 783.

### III. Selected Embodiments of Computing Environments

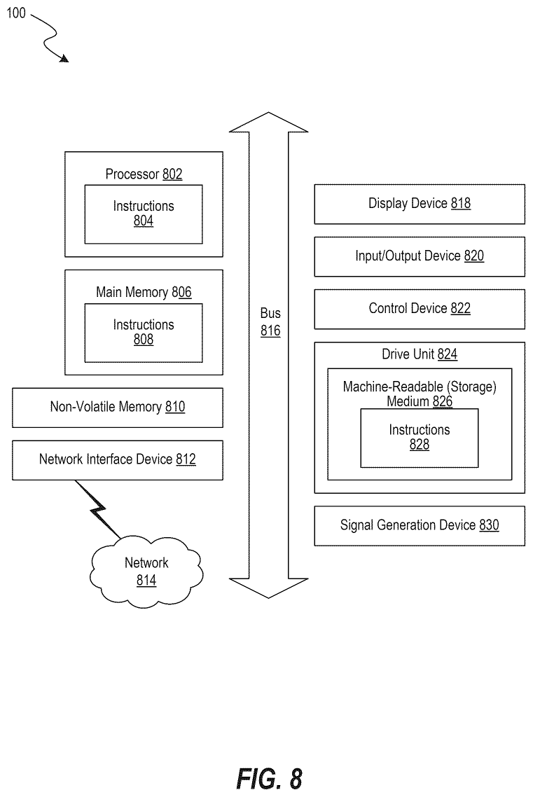

FIG. 8 is a block diagram that illustrates an example of a computer system 800 in which at least some operations described herein can be implemented. The computer system 800 can include: one or more processors 802, a main memory 806, a non-volatile memory 810, a network interface device 812, a display device 818, an input/output device 820, a control device 822 (e.g., keyboard and pointing device), a drive unit 824 that includes a machine readable (storage) medium 826, and a signal generation device 830 that are communicatively connected to a bus 816. The bus 816 represents one or more physical buses and/or point-to-point connections that are connected by appropriate bridges, adapters, and/or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., the main memory 806, the non-volatile memory 810, the machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### IV. Selected Embodiments of Artificial Intelligence and Machine Learning Implementations

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, for example, the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, for example, having a particular architecture, having a particular training procedure, being describable by a set of model hyperparameters, and/or otherwise being varied from the other of the one or more ML models. The validation (or cross-validation) set may then be used as input data into the trained ML models to, for example, measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, for example, fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model”encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails, to identify unintelligible inputs), create content for various purposes (e.g., social media content, factual content, or marketing content), and/or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

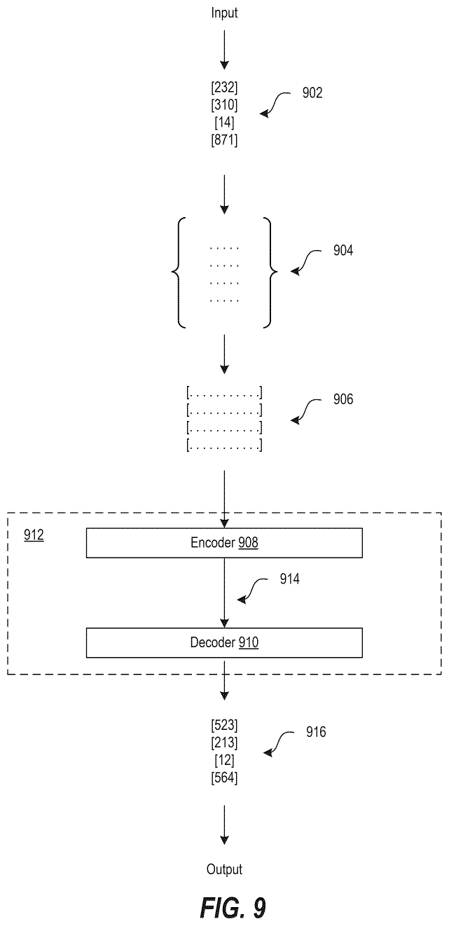

FIG. 9 is a block diagram of an example transformer 912. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 912 includes an encoder 908 (which can include one or more encoder layers/blocks connected in series) and a decoder 910 (which can include one or more decoder layers/blocks connected in series). Generally, the encoder 908 and the decoder 910 each include multiple neural network layers, at least one of which can be a self-attention layer. The parameters of the neural network layers can be referred to as the parameters of the language model.

The transformer 912 can be trained to perform certain functions on a natural language input. Examples of the functions include summarizing existing content, brainstorming ideas, writing a rough draft, fixing spelling and grammar, translating content, and/or the functions attributed to various artificial intelligence (AI) applications described in detail above with reference to FIG. 1-6. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 912 is trained to perform certain functions on other input formats than natural language input. For example, the input can include objects, images, audio content, or video content, or a combination thereof.

The transformer 912 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 9 illustrates an example of how the transformer 912 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 9, a short sequence of tokens 902 corresponding to the input text is illustrated as input to the transformer 912. Tokenization of the text sequence into the tokens 902 can be performed by some pre-processing tokenization module such as, for example, a byte-pair encoding tokenizer (the “pre” referring to the tokenization occurring prior to the processing of the tokenized input by the LLM), which is not shown in FIG. 9 for brevity. In general, the token sequence that is inputted to the transformer 912 can be of any length up to a maximum length defined based on the dimensions of the transformer 912. Each token 902 in the token sequence is converted into an embedding vector 906 (also referred to as “embedding 906”).

An embedding 906 is a learned numerical representation (such as, for example, a vector) of a token that captures some semantic meaning of the text segment represented by the token 902. The embedding 906 represents the text segment corresponding to the token 902 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 906 corresponding to the “write” token will be closer to another embedding corresponding to the “jot down” token in the vector space as compared to the distance between the embedding 906 corresponding to the “write” token and another embedding corresponding to the “summary”token.

The vector space can be defined by the dimensions and values of the embedding vectors. Various techniques can be used to convert a token 902 to an embedding 906. For example, another trained ML model can be used to convert the token 902 into an embedding 906. In particular, another trained ML model can be used to convert the token 902 into an embedding 906 in a way that encodes additional information into the embedding 906 (e.g., a trained ML model can encode positional information about the position of the token 902 in the text sequence into the embedding 206). In some implementations, the numerical value of the token 902 can be used to look up the corresponding embedding in an embedding matrix 904, which can be learned during training of the transformer 912.

The generated embeddings 906 are input into the encoder 908. The encoder 908 serves to encode the embeddings 906 into feature vectors 914 that represent the latent features of the embeddings 906. The encoder 908 can encode positional information (i.e., information about the sequence of the input) in the feature vectors 914. The feature vectors 914 can have very high dimensionality (e.g., on the order of thousands or tens of thousands), with each element in a feature vector 914 corresponding to a respective feature. The numerical weight of each element in a feature vector 914 represents the importance of the corresponding feature. The space of all possible feature vectors 914 that can be generated by the encoder 908 can be referred to as a latent space or feature space.

Conceptually, the decoder 910 is designed to map the features represented by the feature vectors 914 into meaningful output, which can depend on the task that was assigned to the transformer 912. For example, if the transformer 912 is used for a translation task, the decoder 910 can map the feature vectors 914 into text output in a target language different from the language of the original tokens 902. Generally, in a generative language model, the decoder 910 serves to decode the feature vectors 914 into a sequence of tokens. The decoder 910 can generate output tokens 916 one by one. Each output token 916 can be fed back as input to the decoder 910 in order to generate the next output token 916. By feeding back the generated output and applying self-attention, the decoder 910 can generate a sequence of output tokens 916 that has sequential meaning (e.g., the resulting output text sequence is understandable as a sentence and obeys grammatical rules). The decoder 910 can generate output tokens 916 until a special [EOT] token (indicating the end of the text) is generated. The resulting sequence of output tokens 916 can then be converted to a text sequence in post-processing. For example, each output token 916 can be an integer number that corresponds to a vocabulary index. By looking up the text segment using the vocabulary index, the text segment corresponding to each output token 916 can be retrieved, the text segments can be concatenated together, and the final output text sequence can be obtained.

In some implementations, the input provided to the transformer 912 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,049 input tokens), and is able to generate a large number of tokens as output (e.g., up to 2,049 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

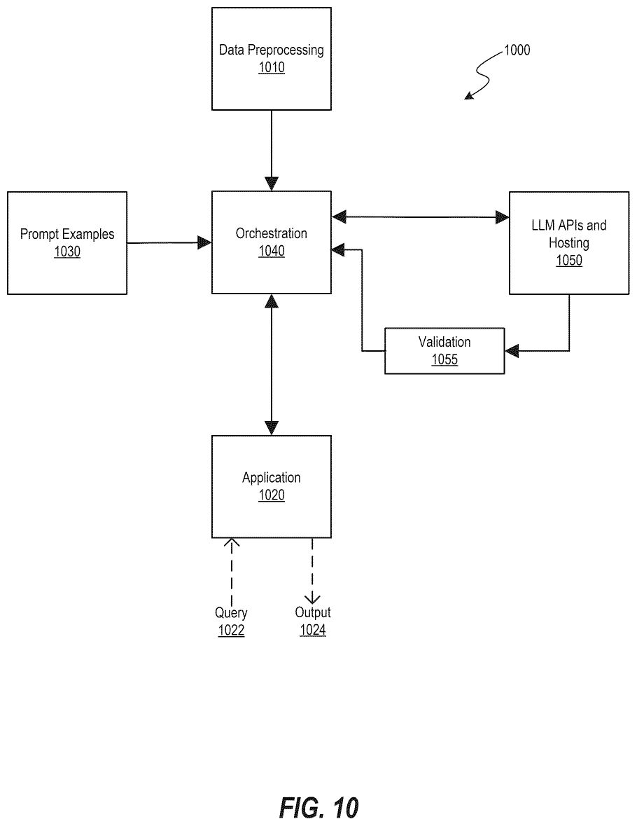

FIG. 10 is a block diagram illustrating an architecture 1000 for LLM applications, according to some implementations. As shown in FIG. 10, the architecture 1000 can include a data preprocessing block 1010, an application 1020, a prompt examples block 1030, an orchestration block 1040, an LLM APIs and Hosting block 1050, and a validation block 1055. Other implementations of the architecture 1000 can include additional, fewer, or different components, or can distribute functionality differently among the components.

The data preprocessing block 1010 manages contextual data and embeddings that can be used to train LLMs or to serve as a data source for an LLM to generate an output. Contextual data can include documents in any of a variety of formats, including text, PDFs, SQL tables, CSV files, images, or code repositories. The data preprocessing block 1010 can retrieve the contextual data from publicly available sources, private sources associated with the application 1020, or a combination of public and private sources.

The data preprocessing block 1010 can generate embeddings of the contextual data or invoke a service to generate the embeddings. The models used to generate embeddings can be trained for the specific model or application in which the embeddings are to be used. Embeddings can be stored in a vector database.

An application 1020 interfaces between a user or external system and the architecture of the LLM. A query 1022 can be input at the application 1020. Based on the query, the application 1020 generates a prompt or series of prompts to cause the LLM to produce a specified output. The application 1020 returns outputs 1024 from the LLM to the requesting user or system.

A prompt is an input to an LLM that instructs the LLM to generate a desired output. Prompts can be structured as a natural language input that includes elements of a user query, hardcoded or dynamically generated prompts templates, data retrieved from external sources at the time the prompt is generated, or other elements that provide contextual data, specific instructions, or validation requirements for the LLM. A computing system, such as the application 1020, generates a prompt that is provided as input to the LLM via the LLM's API. As described above, the prompt may optionally be processed or pre-processed into a token sequence prior to being provided as input to the LLM.

Some prompts can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples can be referred to as a zero-shot prompt. The prompt examples block 1030 provides these example outputs to the LLM for one-shot or few-shot prompts. Example outputs can be provided to the prompt examples block 1030 by a user or developer of the application 1020, in some cases.

The orchestration block 1040 interfaces between LLM application programming interfaces (APIs), the data preprocessing block 1010, the application 1020, the prompt examples block 1030, and/or other data sources or systems. The orchestration block 1040 can submits prompts received from the application 1020 to the LLM. In some implementations, the orchestration block 1040 causes the prompt to be pre-processed into a token sequence prior to being provided as input to the LLM. The orchestration block 1040 can also process prompts to prioritize embeddings that are more relevant to produce a particular output from the LLM or to reorder prompts or embeddings to enable the LLM to produce a contextually relevant response.

The validation block 1055 validates outputs from the LLM before providing the outputs to the requesting application 1020.

### V. Examples

The following examples are illustrative of several embodiments of the present technology:
1. A method of automatically generating a characterization of a surgical procedure, the method comprising:
acquiring surgical procedure data of the surgical procedure including at least a first intraoperative data stream and a second intraoperative data stream, wherein the first intraoperative data stream is different than the second intraoperative data stream, and wherein the first intraoperative data stream is captured simultaneously with the second intraoperative data stream;
determining a first context in the first intraoperative data stream at a time in the first intraoperative data stream;
based on the determined first context, determining a corresponding second context in the second intraoperative data stream at and/or proximate the same time in the second intraoperative data stream;
inputting at least a portion of the first intraoperative data stream, at least a portion of the second intraoperative data stream, the first context, and the second context as inputs into an artificial intelligence (AI) application; and
utilizing the AI application to convert the inputs into one or more natural language descriptions characterizing the surgical procedure.
2. The method of example 1 wherein acquiring the surgical procedure data comprises capturing the first intraoperative data stream and the second intraoperative data stream via a sensor array positioned to view the surgical procedure.
3. The method of example 1 or example 2 wherein the first intraoperative data comprises registration data of a registration of a preoperative model to an anatomical structure of a patient undergoing the surgical procedure, and wherein the second intraoperative data comprises video data.
4. The method of any one of examples 1-3 wherein the first context comprises a surgical action, an anatomical landmark, an instrument identification, an instrument movement, and/or an intraoperative event.
5. The method of any one of examples 1-4 wherein the surgical procedure is a spinal surgical procedure.
6. The method of any one of examples 1-5 wherein the second intraoperative data stream comprises video data.
7. The method of any one of examples 1-6 wherein the one more natural language descriptions characterizing the surgical procedure comprise an operative note describing the surgical procedure.
8. The method of any one of examples 1-7 wherein determining the corresponding second context in the second intraoperative data stream comprises determining the second context in the second intraoperative data stream in a region around the same time in the second intraoperative data stream.
9. The method of any one of examples 1-8 wherein the first intraoperative data stream has a first modality, and wherein the second intraoperative data stream has a second modality different than the first modality.
10. The method of example 9 wherein the first modality comprises registration data, and wherein the second modality comprises video data.
11. A system for automatically generating a characterization of a surgical procedure, the method comprising:
a sensor array including multiple sensors configured to simultaneously capture surgical procedure data of the surgical procedure including at least a first intraoperative data stream and a second intraoperative data stream, wherein the first intraoperative data stream is different than the second intraoperative data stream; and
a surgical characterization processing device programmed with non-transitory computer readable instructions that, when executed by the surgical characterization processing device, cause the surgical characterization processing device to—acquire the surgical procedure data captured by the sensor array;
   determine a first context in the first intraoperative data stream at a time in the first intraoperative data stream;
   based on the determined first context, determine a corresponding second context in the second intraoperative data stream at and/or proximate the same time in the second intraoperative data stream;
   input at least a portion of the first intraoperative data stream, at least a portion of the second intraoperative data stream, the first context, and the second context as inputs into an artificial intelligence (AI) application; and
   utilize the AI application to convert the inputs into one or more natural language descriptions characterizing the surgical procedure.
12. The system of example 11 wherein the surgical characterization processing device is positioned local to the sensor array.
13. The system of example 11 wherein the surgical characterization processing device is positioned remote from the sensor array.
14. The system of any one of examples 11-13 wherein the multiple sensors include RGB cameras, and wherein the second intraoperative data stream comprises RGB image data.
15. The system of any one of examples 11-14 wherein the computer readable instructions, when executed by the surgical characterization processing device, cause the surgical characterization processing device to acquire the surgical procedure data in real time or near real time from the sensor array.
16. The system of any one of examples 11-15 wherein the computer readable instructions, when executed by the surgical characterization processing device, further cause the surgical characterization processing device to:
acquire additional data related to the surgical procedure from a source other than the sensor array;
input the additional data as an additional input to the AI application; and
utilize the AI application to convert the inputs and the additional input into the one or more natural language descriptions characterizing the surgical procedure.
17. The system of example 16 wherein the additional data comprises preoperative image data of a patient undergoing the surgical procedure.
18. The system of any one of examples 11-17 wherein the first intraoperative data comprises registration data of a registration of a preoperative model to an anatomical structure of a patient undergoing the surgical procedure, and wherein the second intraoperative data comprises video data.
19. The system of any one of examples 11-18 wherein the first context comprises a surgical action, an anatomical landmark, an instrument identification, an instrument movement, and/or an intraoperative event.
20. The system of any one of examples 11-19 wherein the first intraoperative data stream has a first modality, and wherein the second intraoperative data stream has a second modality different than the first modality.
21. A method of contextualizing a data stream of a surgical procedure, the method comprising:
acquiring surgical procedure data of the surgical procedure including a video data stream of the surgical procedure and a registration data stream of the surgical procedure, wherein the intraoperative video data stream is captured simultaneously with the registration data stream;
determining a registration of an anatomical feature to the video data stream in the registration data stream; and
based on the determined registration, delineating the anatomical feature in the video stream.
22. The method of example 21 wherein delineating the anatomical feature includes labeling pixels and/or voxels of the video data stream as corresponding to the anatomical feature or not.
23. The method of example 21 or example 22 wherein delineating the anatomical feature includes cropping the pixels and/or voxels of the video data stream corresponding to the anatomical feature.
24. The method of any one of examples 21-23 wherein the anatomical feature is a vertebra.
25. The method of any one of examples 21-24, further comprising:
inputting at least the delineated anatomical feature as an input into an artificial intelligence (AI) application; and
utilizing the AI application to convert the input into one or more natural language descriptions characterizing the surgical procedure.

### VI. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of contextualizing a data stream of a surgical procedure, the method comprising:
acquiring surgical procedure data of the surgical procedure including a video data stream of the surgical procedure and a registration data stream of the surgical procedure, wherein the intraoperative video data stream is captured simultaneously with the registration data stream;
determining a registration of an anatomical feature to the video data stream in the registration data stream; and
based on the determined registration, delineating the anatomical feature in the video stream.

2. The method of claim 1 wherein delineating the anatomical feature includes labeling pixels and/or voxels of the video data stream as corresponding to the anatomical feature or not.

3. The method of claim 1 wherein delineating the anatomical feature includes cropping the pixels and/or voxels of the video data stream corresponding to the anatomical feature.

4. The method of claim 1 wherein the anatomical feature is a vertebra.

5. The method of claim 1, further comprising:
inputting at least the delineated anatomical feature as an input into an artificial intelligence (AI) application; and
utilizing the AI application to convert the input into one or more natural language descriptions characterizing the surgical procedure.

6. A method of automatically generating a characterization of a surgical procedure, the method comprising:
acquiring surgical procedure data of the surgical procedure including at least a first intraoperative data stream and a second intraoperative data stream, wherein the first intraoperative data stream is different than the second intraoperative data stream, and wherein the first intraoperative data stream is captured simultaneously with the second intraoperative data stream;
determining a first context in the first intraoperative data stream at a time in the first intraoperative data stream;
based on the determined first context, determining a corresponding second context in the second intraoperative data stream at and/or proximate the same time in the second intraoperative data stream;
inputting at least a portion of the first intraoperative data stream, at least a portion of the second intraoperative data stream, the first context, and the second context as inputs into an artificial intelligence (AI) application; and
utilizing the AI application to convert the inputs into one or more natural language descriptions characterizing the surgical procedure.

7. The method of claim 6 wherein acquiring the surgical procedure data comprises capturing the first intraoperative data stream and the second intraoperative data stream via a sensor array positioned to view the surgical procedure.

8. The method of claim 6 wherein the first intraoperative data comprises registration data of a registration of a preoperative model to an anatomical structure of a patient undergoing the surgical procedure, and wherein the second intraoperative data comprises video data.

9. The method of claim 6 wherein the first context comprises a surgical action, an anatomical landmark, an instrument identification, an instrument movement, and/or an intraoperative event.

10. The method of claim 6 wherein the surgical procedure is a spinal surgical procedure.

11. The method of claim 6 wherein the second intraoperative data stream comprises video data.

12. The method of claim 6 wherein the one more natural language descriptions characterizing the surgical procedure comprise an operative note describing the surgical procedure.

13. The method of claim 6 wherein determining the corresponding second context in the second intraoperative data stream comprises determining the second context in the second intraoperative data stream in a region around the same time in the second intraoperative data stream.

14. The method of claim 6 wherein the first intraoperative data stream has a first modality, and wherein the second intraoperative data stream has a second modality different than the first modality.

15. The method of claim 14 wherein the first modality comprises registration data, and wherein the second modality comprises video data.

16. A system for automatically generating a characterization of a surgical procedure, the method comprising:
a sensor array including multiple sensors configured to simultaneously capture surgical procedure data of the surgical procedure including at least a first intraoperative data stream and a second intraoperative data stream, wherein the first intraoperative data stream is different than the second intraoperative data stream; and
a surgical characterization processing device programmed with non-transitory computer readable instructions that, when executed by the surgical characterization processing device, cause the surgical characterization processing device to—acquire the surgical procedure data captured by the sensor array;
determine a first context in the first intraoperative data stream at a time in the first intraoperative data stream;
based on the determined first context, determine a corresponding second context in the second intraoperative data stream at and/or proximate the same time in the second intraoperative data stream;
input at least a portion of the first intraoperative data stream, at least a portion of the second intraoperative data stream, the first context, and the second context as inputs into an artificial intelligence (AI) application; and
utilize the AI application to convert the inputs into one or more natural language descriptions characterizing the surgical procedure.

17. The system of claim 16 wherein the surgical characterization processing device is positioned local to the sensor array.

18. The system of claim 16 wherein the surgical characterization processing device is positioned remote from the sensor array.

19. The system of claim 16 wherein the multiple sensors include RGB cameras, and wherein the second intraoperative data stream comprises RGB image data.

20. The system of claim 16 wherein the computer readable instructions, when executed by the surgical characterization processing device, cause the surgical characterization processing device to acquire the surgical procedure data in real time or near real time from the sensor array.

21. The system of claim 16 wherein the computer readable instructions, when executed by the surgical characterization processing device, further cause the surgical characterization processing device to:
acquire additional data related to the surgical procedure from a source other than the sensor array;
input the additional data as an additional input to the AI application; and
utilize the AI application to convert the inputs and the additional input into the one or more natural language descriptions characterizing the surgical procedure.

22. The system of claim 16 wherein the additional data comprises preoperative image data of a patient undergoing the surgical procedure.

23. The system of claim 16 wherein the first intraoperative data comprises registration data of a registration of a preoperative model to an anatomical structure of a patient undergoing the surgical procedure, and wherein the second intraoperative data comprises video data.

24. The system of claim 16 wherein the first context comprises a surgical action, an anatomical landmark, an instrument identification, an instrument movement, and/or an intraoperative event.

25. The system of claim 16 wherein the first intraoperative data stream has a first modality, and wherein the second intraoperative data stream has a second modality different than the first modality.
